(19) United States
(12) Patent Application Publication
(10) Pub. No.: US 2006/0059130 A1
(43) Pub. Date: Mar. 16, 2006

(54) System and method of automatically modifying an online dating service search using compatibility feedback

(75) Inventors: Aaron F. Weiss, San Jose, CA (US); Jianzhen J. Sun, San Jose, CA (US); Wei Wang, Atherton, CA (US); Egon Smola, Mountain View, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/012,543

(22) Filed: Dec. 14, 2004

Related U.S. Application Data
(60) Provisional application No. 60/610,125, filed on Sep. 15, 2004.

(51) Int. Cl. G06F 17/30

(52) U.S. Cl. 707/3

(57) ABSTRACT

A system and method are directed towards automatically modifying an online dating service's search results based on a user's compatibility feedback. A user provides input to a series of questions that seek information regarding the user. The invention employs the input to identify a list of candidates for a potential long-term social relationship with the user. The invention may analyze the user's evaluation of the candidates for possible adjustments, by modifying the candidate list based on, for example, whether the user has contacted a candidate, a frequency of the user's contacts with a candidate, an order in which the user contacts candidates, and other compatibility feedback of the candidates by the user. Based on the user's compatibility feedback, the invention automatically adjusts the search rankings for the user's search results and updates the potential candidate list.

### CROSS-REFERENCE TO RELATED APPLICATIONS

This application claims the benefit of U.S. Provisional Application Ser. No. 60/610,125 filed on Sep. 15, 2004, the benefit of the earlier filing date of which is hereby claimed under 35 U.S.C. §119 (e) and further incorporated by reference.

### FIELD OF THE INVENTION

The present invention relates generally to online dating services, and more particularly, but not exclusively, to a system and method for automatically modifying search criteria, based, at least in part, on a user compatibility feedback.

### BACKGROUND OF THE INVENTION

Dating services are now so popular that by at least one study for the given year, over twenty-six percent of all Internet users in America have visited a personals website. Part of the reason may be that online dating may appear to be a natural extension of where people are at this point in time. That is, many people today, have personal computers, or at least access to a personal computer. Moreover, virtually everyone wants to fall in love. Thus, it is natural to merge these two things. As such, online dating services may appear as the world's biggest singles bar. Except that it can be done in the privacy of one's own home where time may be taken to read about another person and get to know them through email, phone, and the like, before ever going on an actual date.

Thus, there has been a flurry of companies launching services that help people to meet and develop a personal relationship. Many of these companies, however, are struggling with developing additional services that will build customer loyalty. Without the ability to extend the value of the online dating experience, online dating may lose its appeal. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention; and

FIG. 3 illustrates a logical flow diagram generally showing one embodiment of a process for employing user compatibility feedback to automatically modify an online dating search, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards automatically modifying an online dating service's search results based, at least in part, on a user's compatibility feedback. A user provides information about themselves by answering a series of questions, including questions about their personality and relationship compatibilities, and optionally other social aspects associated with the user. The invention employs the information to identify a potential candidate list for a long-term social relationship with the user. The invention may then analyze the user's evaluation of the candidates for possible adjustments. For example, the invention may automatically modify the candidate list based on whether the user has contacted a candidate, a frequency of the user's contacts with a candidate, and an order in which the user contacts candidates. Additionally, the invention may prompt the user to rate candidates. In one embodiment, the user may rate candidates based on a variety of additionally provided questions. Based on the user's compatibility feedback, the invention may automatically adjust an order in which the user's search results are presented and may also modify the potential candidate list. In one embodiment, the invention may employ the user's compatibility feedback to adjust weights of search variables that are employed in the search for candidates.

The user's initial input may be obtained employing a variety of techniques. For example, in one embodiment, the user takes a personality type and love style test that is directed towards quantifying key personality attributes, including a degree of extroversion, agreeableness, conscientiousness, neuroticism, and openness of the user. Additionally, the user may elect to take an additional test that is directed towards personality elements that are considered relevant in a relationship. Such questions may, for example, seek to identify for the user, personality traits in dimensions such as relationship readiness, relationship expectations, ambition, a desire to have children, emotional IQ, stereotypic gender roles, conflict resolution, and so forth.

Illustrative Operating Environment

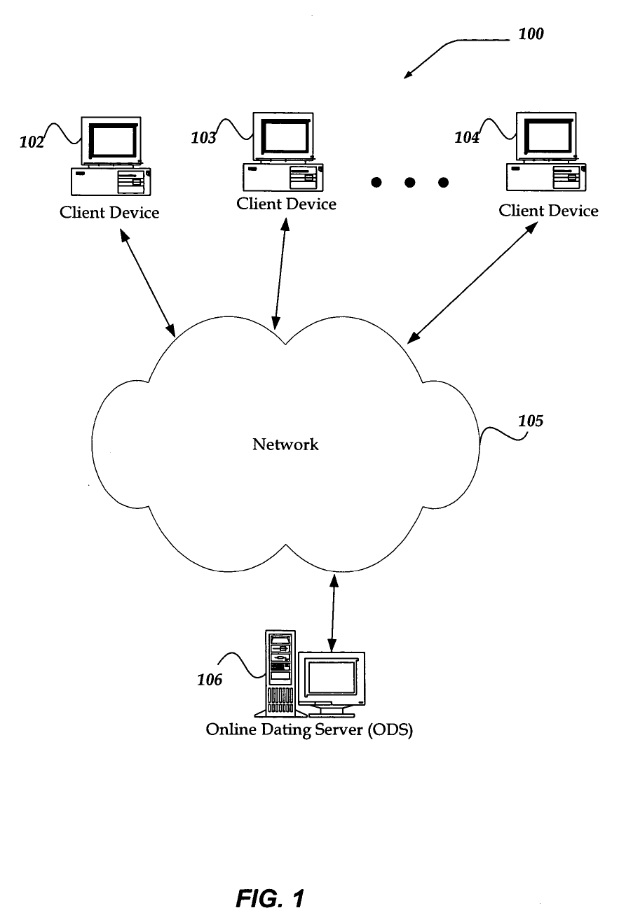

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes client devices 102-104, network 105, and online dating server (ODS) 106. Network 105 is in communication with and enables communication between each of client devices 102-104, and ODS 106.

Client devices 102-104 may include virtually any computing device capable of receiving and sending a message over a network, such as network 105, to and from another computing device, such as ODS 106, each other, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client devices 102-104 may be any device that is capable of connecting using a wired or wireless communication medium such as a PDA, POCKET PC, wearable computer, and any other device that is equipped to communicate over a wired and/or wireless communication medium.

Each client device within client devices 102-104 may include a browser application that is configured to receive and to send web pages, web-based messages, and the like. The browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Client devices 102-104 may be further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

Client devices 102-104 may be further configured to enable a user to participate in an online dating service, manage personal user information associated with the online dating service, and the like, which may in turn be saved at a location, such as ODS 106, and the like. As such, client devices 102-104 may further include a client application that is configured to manage various actions on behalf of the client device. For example, the client application may enable a user to interact with the browser application, email application, and the like, to manage their online dating information. For example, the user may employ the client application, in part, to create a user profile, participate in an online dating personality compatibility analysis, relationship compatibility, and the like, such as a personality type and love styles test, a relationship test, and the like. The client application may further enable the user to receive and interact with results of a search that is based, at least in part, on the user's input to the online dating service. Moreover, the client application further enables the user to provide compatibility feedback to the online dating service regarding the results of the search, and to receive and interact with results that are automatically revised based on the user's compatibility feedback.

The client application also may interact with various other components of the system as described in more detail below. For example, in at least one embodiment, the client application is configured to enable the user to provide a fee for at least a portion of the online dating service.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between client devices 102-104, and ODS 106.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

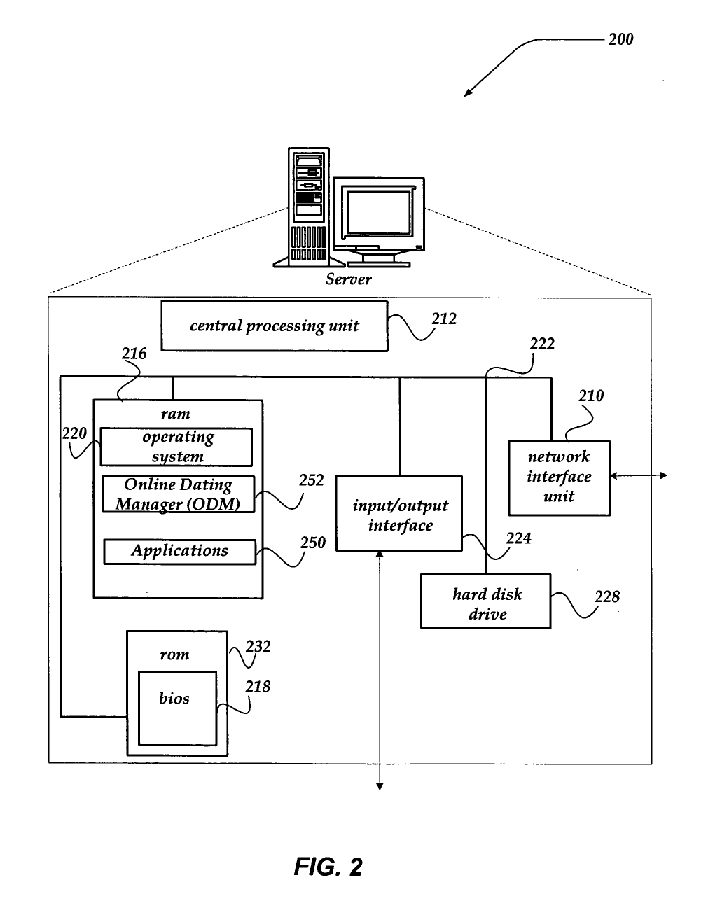

One embodiment of ODS 106 is described in more detail below in conjunction with FIG. 2. Briefly, however, ODS 106 may include any computing device capable of connecting to network 105 to enable a user of at least one of client devices 102-104 to manage their online dating activities and related information. Devices that may operate as ODS 106 include personal computers desktop computers, multiprocessor systems, microprocessor-based or programmable consumer electronics, network PCs, servers, and the like.

It is noted that while FIG. 1 illustrates a single computing device operable as ODS 106, the invention is not so limited. For example, the actions attributable to ODS 106 may be distributed across multiple computing devices, such as a group of servers, a network cluster, and the like, without departing from the scope or spirit of the invention.

Illustrative Server Environment

FIG. 2 shows one embodiment of a server device, according to one embodiment of the invention. Server device 200 may include many more components than those shown. The components shown, however, are sufficient to disclose an illustrative embodiment for practicing the invention.

Server device 200 includes processing unit 212, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server 102. Any general-purpose operating system may be employed. Basic input/output system (“BIOS”) 218 is also provided for controlling the low-level operation of server 102. As illustrated in FIG. 2, server device 200 also can communicate with the Internet, or some other communications network, such as network 105 in FIG. 1, via network interface unit 210, which is constructed for use with various communication protocols including the TCP/IP protocol. Network interface unit 210 is sometimes known as a transceiver, transceiving device, network interface card (NIC), and the like.

Server device 200 may also include an SMTP handler application for transmitting and receiving email. Server device 200 may also include an HTTP handler application for receiving and handing HTTP requests, and an HTTPS handler application for handling secure connections. The HTTPS handler application may initiate communication with an external application in a secure fashion.

Server device 200 also includes input/output interface 224 for communicating with external devices, such as a mouse, keyboard, scanner, or other input devices not shown in FIG. 2. Likewise, server device 200 may further include additional mass storage facilities such as hard disk drive 228. Hard disk drive 228 is utilized by server 102 to store, among other things, application programs, databases, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, web services, transcoders, database programs, word processing programs, spreadsheet programs, and so forth. Mass storage may further include applications such as online dating manager (ODM) 252.

ODM 252 enables a user to manage their online dating user information, communicate with other users, and non-users, and to generally pursue an online dating relationship. ODM 252 provides a variety of features to enable a user of a client device to participate in the online dating experience.

For example, ODM 252 enables a user to search for another person in the online dating service based, in part, on the user's compatibility feedback. After identifying candidates for a user based on personality and relationship compatibility and optionally other components, ODM 252 may analyze the user's evaluation of candidates for possible adjustments. For example, whether the user has contacted a candidate, the frequency of the user's contacts with the candidate, and the order in which the user contacted the candidates may serve as indicators of the user's opinion of the candidate. ODM 252 may further prompt the user to rate candidates. Based on the user's compatibility feedback, ODM 252 may automatically adjust a unified search score for potential candidates. ODM 252 may then employ the adjusted unified search scores to re-rank potential candidates and then present the re-ranked results to the user.

ODM 252 may employ a variety of mechanisms to enable the user to rate the candidates. For example, ODM 252 may enable the user to select a rating designation from an n-pointed value, employ a slider bar for evaluating the candidate, a button, drop-down menu, and the like. In one embodiment, the user may provide a global value as their compatibility feedback for the candidate. In another embodiment, the user may provide multiple values as their compatibility feedback for various aspects of the candidate.

In one embodiment, ODM 252 may enable the user to take various tests. The results of these tests may be employed in the search for candidates of a potentially long term relationship with the user. For example, ODM 252 may allow the user to participate in a personality type and love style test or in a relationship test. However, the invention is not so limited, and other tests may be employed without departing from the scope or spirit of the invention.

The results of these tests, as well as other inputs may be employed to determine a unified search score for use in performing the candidate search. In one embodiment, the compatibility feedback may be employed to adjust an overall unified search score by operating as a single weighted value within a sum of weighted values.

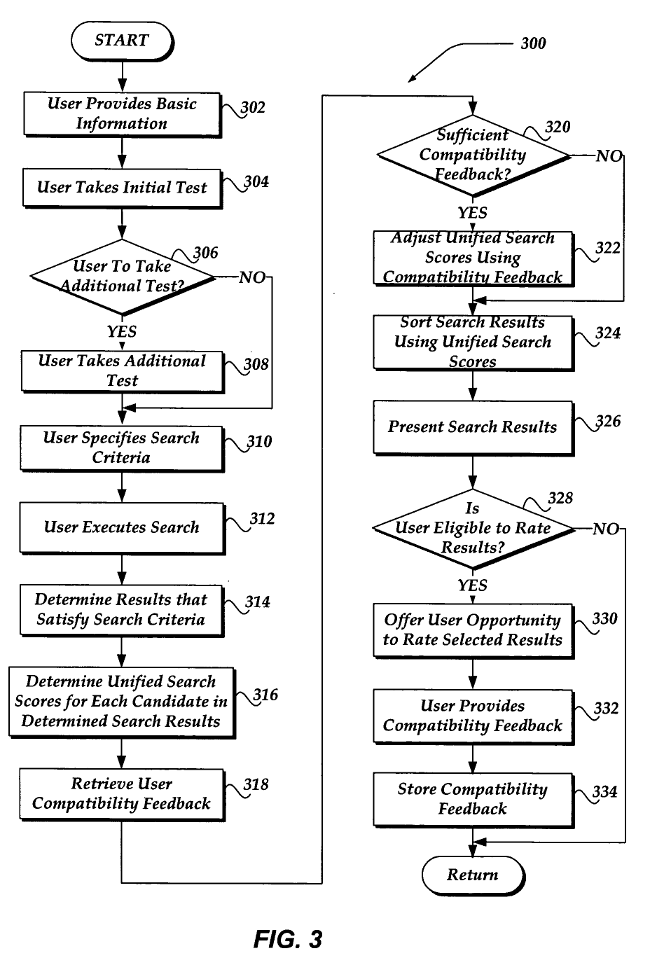

Moreover, ODM 252 may employ a process, such as process 300 described below in conjunction with FIG. 3 to perform actions, such as those described above.

Furthermore, ODM 252's associated actions and/or sub-components may be decomposed and distributed across multiple computing devices similar to server device 200 of FIG. 2. For example, rating data may be distributed across one set of servers, while searches may be performed employing a sub-component of ODM 252 distributed across another set of servers. A search data store sub-component of ODM 252 may also be distributed across one of more computing devices. In addition, a user interface sub-component of ODM 252 may be distributed across still another server, array of servers, and the like.

Generalized Operation

The operation of certain aspects of the invention will now be described with respect to FIG. 3. FIG. 3 illustrates a logical flow diagram generally showing one embodiment of process 300 for employing user compatibility feedback to automatically modify an online dating search, in accordance with the present invention.

As shown in the figure, process 300 typically begins, after a start block, at block 302, when a user indicates intent to participate in a long-term serious relationship and is willing to openly communicate this desire to others. At block 302, the user provides basic information about them self, including such information as name, alias, age, gender, and so forth.

Processing next flows to block 304, where the user participates in an initial test for compatibility. In one embodiment, the test is a personality type and love style test that focuses on such personality elements as degree of extroversion, agreeableness, conscientiousness, neuroticism, openness, and so forth. However, the test is not so constrained, and virtually any test, series of questions, and the like, may be employed to enable the invention to obtain compatibility information about the user. The test may employ any of a variety of techniques to obtain such personality elements, including, providing questions, surveys, graphics, interactive audio clips, interactive video clips, and the like. In one embodiment, the results of the initial test may be provided to the user for review and/or refinement. The results may be presented to the user in a variety of formats, including a written summary that is organized based on personality, love style, and the like.

Processing proceeds next to decision block 306, where the user is offered an opportunity to submit to additional testing. If the user so elects, processing continues to block 308; otherwise, processing branches to block 310.

At block 308, the user participates in additional testing, such as personality and relationship testing. In one embodiment, the additional testing is directed towards personality elements such as relationship readiness, relationship expectations, ambition, a desire to have children, emotional IQ, stereotypic gender roles, conflict resolution, and so forth. However, the invention is not constrained to these example elements, and others may be tested, without departing from the scope or spirit of the invention. Upon completion of the additional testing, the user may be provided the results. Process 300 flows next to block 310.

At block 310, the user may specify demographic criteria of the prospective partner(s) whom they wish to find in the search. In one embodiment, these criteria may include attributes such as age, height, gender, religion, ethnicity, degree of educational attainment, profession, vocational interests, and so forth. However the invention is not constrained to these example elements, and others may be included, without departing from the scope or spirit of the invention. In one embodiment, the demographic criteria may be designated as must-have, nice-to-have, and the like. As such, the must-have criteria may, for example, identify criteria that, if unmet, might exclude a candidate from a candidate pool. Upon completion of the specification of demographic criteria, process 300 flows next to block 312.

At block 312, the user requests that a search be performed based on the criteria specified in block 310 and further utilizing the information about the user provided at blocks 302, 304, and 308. Upon submission of this request processing proceeds to block 314.

At Block 314, candidates are selected from a database of candidates who may satisfy the criteria specified in 310. In one embodiment, the results include at least those candidates that satisfy the must-have criteria. Processing then continues to block 316, where a unified search score (USS) may be determined for each candidate in the pool of candidates determined at block 314. In one embodiment, the USS may represent a composite search ranking score determined from a weighted sum of various subscores. The subscores may, for example, be based, at least in part, on the results of the tests the user has taken, and any additional input the user may have provided at block 310. For example, the additional input from the user may include whether a particular aspect of the candidate is desired, not desired, must-have, nice-to-have, and the like. For example, the user may indicate that the candidate must be located within so many miles from the user, be a particular gender, within a particular age range, and so forth.

Additional factors may also be employed to generate the USS. Such additional factors, may include, an indication of the degree to which a candidate found by the search matches the user's criteria (one-way search), how much the user matches the criteria of a candidate found by a search (reverse search), indication of an activity level such as whether a candidate logged into the online dating service recently (activity level), an affinity indicating whether a candidate has a degree of closeness with another candidate found by a search (affinity), a previous level of interest indicating whether the user has viewed the same candidate before and did not contact the candidate, an input factor reflecting the number of replies the candidate's profile has recently received, and so forth.

In one embodiment, the inputs, and other factors are employed to generate the USS:
USS=Sum(WᵢIᵢ), for i=1 through n,

where Wᵢ represents a weight for input factor Iᵢ. The input factors may include a variety of information. For example, in one embodiment, the USS may be determined based on an input factor associated with the initial test, the additional test, a one-way search criteria input factor, a reverse search criteria input factor, an activity input factor, a distance input factor, an affinity input factor, compatibility feedback input factor, and the like. However, the invention is not so limited, and virtually any input factor may be employed.

Processing next flows to block 318, where any prior compatibility feedback associated with the user may also be incorporated as an input factor, I, for determining the USS. Such compatibility feedback may for example, have been obtained at block 332, from a prior execution of process 300 for this user. Process 300 continues to decision block 320, where a determination is made whether a sufficient amount of compatibility feedback is available for the given user. A sufficient amount may be determined employing any of a variety of mechanisms, including engineering judgment, and the like. In one embodiment, a sufficient amount may be set to a predetermined number compatibility feedback inputs. In one embodiment, as described at decision block 328, the user may not be eligible to have compatibility feedbacks. In any event, if a sufficient amount of compatibility feedback is available processing flows to block 322; otherwise, processing branches to block 324.

At block 322 the sufficient compatibility feedback determined at decision block 320 are employed to the profiles for each candidate. In one embodiment, the compatibility feedback input factor, I, may include an average compatibility feedback for a candidate's personality type. In an absence of a sufficient amount of compatibility feedback, the compatibility feedback input factor, I, may be set to zero. Each candidate's USS may then be revised to include the weighted compatibility feedback, W*I.

Processing flows next to block 324, where candidates may be sorted based, in part, on their respective resulting USS. Processing flows to block 326, where the sorted candidate list is provided to the user. In one embodiment, the provided candidate list includes a predetermined number of candidates. For example, in one embodiment, the sorted candidate list may include a top most 1000 candidates. In another embodiment, the sorted candidate list is presented to the user in a navigable sequence of web pages. Processing continues next to decision block 328.

At decision block 328, a determination is made whether the user is eligible to rate the results using compatibility feedbacks. Virtually any criteria may be employed to determine a user's eligibility, including whether the user has paid a fee, received a coupon offer, and the like. In any event, if the user is eligible, processing flows to block 330; otherwise, process 300 returns to a calling process to perform other actions.

At block 330, the user is provided an opportunity to rate the presented candidate search results from block 326. The user may select a candidate's profile where the user may provide then be presented a menu, and the like, for entering a compatibility feedback. Processing flows next to block 332, where the user may provide a compatibility feedback on a candidate. User compatibility feedback may also be provided employing a variety of other techniques. For example, the invention may automatically determine compatibility feedback based on whether the user has contacted the candidate in the current search results, based on a frequency of the user's contacts with the candidate, based on an order in which the user contacted candidates, and the like.

The invention may also prompt the user to rate or evaluate candidates on the current candidate list. For example, the user may be provided a slider bar, a drop-down menu, a button input, radio input, and the like, that allows the user to indicate an overall rating for a candidate. In one embodiment, the user may provide a rating of the candidate using a scale that includes, for example, an n-pointed range of discrete values, such as ±1.0, ±0.5, and 0. However, the invention is not so limited, and the user may also provide a fractional rating for the selected candidate. For example, the user may be provided a slider bar that enables rating of the candidate with an overall subjective compatibility value, such as “excellent,” “good,” “fair,” and so forth.

Virtually any compatibility feedback may be employed to determine at least one compatibility input factor, I, for use in revising a candidate's USS. For example, in another embodiment, the user may be enabled to provide multiple-input compatibility feedback about a selected candidate. The user may be enabled to provide a compatibility feedback based on physical characteristics of the candidate, social characteristics of the candidate, and so forth. In one embodiment, the multiple-input compatibility feedback is combined into a single input factor, I, for use in the USS described above. In another embodiment, the multiple-input compatibility feedback is employed to modify an appropriate other input factor to the USS.

Processing continues to block 334, where the compatibility feedbacks determined at block 332 may be stored for use in another search. In one embodiment, the compatibility feedback is automatically employed to revise the ratings of the search results at block 322. Thus, although not illustrated in FIG. 3, process 300 may loop back after block 334 to block 310 and continue until the user so indicates intent to no longer revise the search results. In that instance, processing returns to another process to perform other actions.

In addition, the user is not wholly constrained to flow illustrated in FIG. 3 in other ways. For example, the user may execute a search at block 312, review the results at block 326, and revise the criteria at block 310, without being constrained to view any of the candidate's profiles at block 332. Moreover, the user may elect to retake a test, revise their basic information and the like, without proceeding to perform a search, during a given session. Thus, it is apparent that FIG. 3 is but one embodiment of a process for employing compatibility feedback to automatically modify an online dating search.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for use in managing an online dating search, comprising:
determining a user's search criteria for a candidate for a dating relationship online;
performing a search for a list of candidates employing the search criteria;
ranking each candidate in the list of candidates;
determining compatibility feedback for at least one candidate in the ranked list of candidates; and
employing the compatibility feedback to automatically revise the ranking of the candidates in the list of candidates.

2. The method of claim 1, wherein determining the compatibility feedback further comprises, determining if the user has contacted a candidate, determining a frequency of the user's contacts with a candidate, determining an order in which the user has contacted at least two candidates, and requesting the user to rate the at least one candidate.

3. The method of claim 2, wherein determining compatibility feedback further comprises, requesting the user to rate the at least one candidate further comprises at least one of requesting the user to provide a discrete value associated with the at least one candidate, and to employ at least one of a slider bar, a drop-down menu, and a button, to rate the at least one candidate.

4. The method of claim 1, wherein employing the compatibility feedback further comprises:
determining if a predetermined amount of compatibility feedback is available, and if the predetermined amount is unavailable, setting a compatibility feedback input factor to zero, such that the compatibility feedback provides minimum influence to the revised ranking of candidates.

5. The method of claim 1, wherein employing the compatibility feedback further comprises determining whether a predetermined amount of compatibility feedback is available.

6. The method of claim 1, wherein revising the ranking of the candidates further comprises:
determining a unified search score for each candidate, in part, by combining a weighted input factor associated with the compatibility feedback with at least one other weighted input factor; and
employing the unified search score to re-rank each candidate in the list of candidates.

7. The method of claim 6, wherein the at least one other weighted input factor further comprises a weighting value combined with at least one of an initial user test, an additional user test, a one-way search criteria input factor, a reverse search criteria input factor, an activity input factor, a distance input factor, an input factor reflecting the number of times the user has viewed this candidate's profile, an input factor reflecting the number of replies the candidate's profile has recently received, and an affinity input factor.

8. The method of claim 1, wherein the user employs a mobile device to communicate with the method of claim 1.

9. A client device that is configured for use in communicating an online dating search, comprising:
a display;
a transceiver for receiving and sending information to another computing device;
a processor in communication with the display and the transceiver; and
a memory in communication with the processor and storing data and machine instructions that causes the processor to perform a plurality of operations, including:
providing a user's search criteria for a candidate;
enabling a search for a list of candidates employing the search criteria;
receiving a ranking of each candidate in the list of candidates;
providing compatibility feedback for at least one candidate in the ranked list of candidates; and
employing the compatibility feedback to revise the ranking of the candidates in the list of candidates.

10. The client device of claim 9, wherein the client device further comprises a mobile device.

11. The client device of claim 9, wherein providing the compatibility feedback further comprises, providing information about whether the user has contacted a candidate, providing information about a frequency of the user's contacts with a candidate, providing an order in which the user has contacted at least two candidates, and providing a user rating for the at least one candidate.

12. The client device of claim 11, wherein providing the user rating for the at least one candidate further comprises at least one of requesting the user to provide a discrete value associated with the at least one candidate, and to employ at least one of a slider bar, a button, and a drop-down menu, to rate the at least one candidate.

13. The client device of claim 9, wherein employing the compatibility feedback further comprises:
employing the compatibility feedback to determine a unified search score by combining a weighted input factor associated with the compatibility feedback with at least one other weighted input factor; and
employing the unified search score to re-rank the candidates in the list of candidates.

14. The client device of claim 13, wherein the at least one other weighted input factor further comprises a weighting value combined with at least one of an initial user test, an additional user test, a one-way search criteria input factor, a reverse search criteria input factor, an activity input factor, a distance input factor, an input factor reflecting the number of times the user has viewed this candidate's profile, an input factor reflecting the number of replies the candidate's profile has recently received, and an affinity input factor.

15. The client device of claim 9, wherein providing compatibility feedback further comprises employing a stored compatibility feedback to revise the ranking of the candidates in the list of candidates.

16. A server that is configured for use in managing an online dating search, comprising:
a transceiver for receiving and sending information to another computing device;
a processor in communication with the transceiver; and
a memory in communication with the processor and storing data and machine instructions that cause the processor to perform a plurality of operations, including:
receiving a user's search criteria for a candidate;
performing a search for a list of candidates employing the search criteria;
providing a ranking of each candidate in the list of candidates;
receiving compatibility feedback for at least one candidate in the ranked list of candidates;
employing the compatibility feedback to revise the ranking of the candidates in the list of candidates; and
providing the revised ranking of the candidates in the list of candidates.

17. The server of claim 16, wherein the other computing device is a mobile device employable by the user to communicate with the server.

18. The server of claim 16, wherein revising the ranking of the candidates further comprises determining a unified search score by combining a weighted input factor associated with the compatibility feedback with at least one other weighted input factor; and employing the revised unified search score to re-rank the candidates in the list of candidates.

19. The server of claim 16, wherein the at least one other weighted input factor further comprises a weighting value combined with at least one of an initial user test, an additional user test, a one-way search criteria input factor, a reverse search criteria input factor, an activity input factor, a distance input factor, an input factor reflecting the number of times the user has viewed this candidate's profile, an input factor reflecting the number of replies the candidate's profile has recently received, and an affinity input factor.

20. The server of claim 16, wherein providing the revised ranking further comprises:
determining information associated with the user by at least one of requesting user information, and requesting the user to participate in at least one test;
determining a unified search score using, in part, the determined information; and
employing the unified search score to determined the revised ranking of each candidate.

21. The server of claim 20, wherein the unified search score further comprises the compatibility feedback.

22. A modulated data signal for managing an online dating search over a network, the modulated data signal comprising instructions that enable a computing device to perform the actions of:
sending, from a client device, a user's search criteria for a candidate;
enabling, at a server, a search for a list of candidates employing the search criteria;
presenting, at the client device, a ranking of each candidate in the list of candidates;
receiving, from the client device, user compatibility feedback for at least one candidate in the ranked list of candidates; and
employing the compatibility feedback to revise the ranking of the candidates in the list of candidates.

23. The modulated data signal of claim 22, wherein the client device is a mobile device.

24. The modulated data signal of claim 22, wherein employing the compatibility feedback further comprises:
employing the compatibility feedback to determine a unified search score; and
employing the unified search score to re-rank the candidates in the list of candidates.

25. The modulated data signal of claim 22, further comprising, presenting to the client device not more than a predetermined number of candidates in the list of candidates.

26. The modulated data signal of claim 22, wherein providing the list of candidates further comprises providing the list in a rank order based, in part, on a unified search score.

27. An apparatus of managing an online dating search, comprising:
a means for determining a user's search criteria for a candidate;
a means for performing a search for a list of candidates employing the search criteria;
a means for presenting a ranking of each candidate in the list of candidates;
a means for determining compatibility feedback for at least one candidate in the ranked list of candidates; and
a means for employing the compatibility feedback to revise the ranking of the candidates in the list of candidates.
